(19) United States
(12) Patent Application Publication
(10) Pub. No.: US 2002/0086714 A1
(43) Pub. Date: Jul. 4, 2002

(54) In-coming call indicating means for mobile phone

(76) Inventor: Ching-Hung Wang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/750,172

(22) Filed: Dec. 29, 2000

(51) Int. Cl. H04B 1/38; H04M 1/00

(52) U.S. Cl. 455/567; 455/90; 455/575

(57) ABSTRACT

An in-coming call indicating means for mobile phone is provided. The means includes a frequency receptor that is adapted to receive communicating signals sent to a mobile phone, and a luminescence starter that includes a power circuit and a driving circuit adapted to receive a signal output by the frequency receptor and to output driving power to a luminescent indicating strip connected thereto The luminescent indicating strip gives out luminescence whenever there is an in-coming call over the mobile phone, so that a user of the mobile phone could be timely notified of the in-coming call even the mobile phone is in a “ring off” and “vibration off” state.

### BACKGROUND OF THE INVENTION

There are times a mobile phone is set to “ring off” and/or “vibration off” to avoid unnecessary disturbance at some special occasion, such as in a meeting. It is therefore desirable to develop another way, such as a visual type of signal, for example, a luminescence, to inform a mobile phone user of in-coming calls without disturbing the user.

### SUMMARY OF THE INVENTION

A primary object of the present invention is to provide an in-coming call indicating means that is in the form of a ring or a strip for mounting on a mobile phone or a bag for receiving a mobile phone and is adapted to give out luminescence whenever there is an in-coming call over the mobile phone. The ring-shaped or strip-shaped luminescent in-coming call indicating means is usually mounted on an outer side of the mobile phone and has large area for easy exposure from the mobile phone bag or other bag holding the mobile phone, so that the luminescent means is always visible from outside of the mobile phone to effectively notify the user's of an in-coming call. The luminescent in-coming call indicating means may be powered with external batteries or with the battery for the mobile phone. It is also possible to amplify the electromagnetic waves generated when the mobile phone receives or sends signals and use the amplified electromagnetic waves as the power for the in-coming call indicating means.

Another object of the present invention is to provide an in-coming call indicating means for mobile phone, of which a luminescent ring or strip may be hung on a user's wrist or neck as an ornament.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a luminescent in-coming call indicating means according to a first embodiment of the present invention;

FIG. 2 is a block diagram for an in-coming call indicating means according to the present invention;

FIG. 3 is a fragmentary cross section of a luminescent indicating strip according to the first embodiment of the present invention;

FIG. 4 is a fragmentary plan view of the luminescent indicating strip according to the first embodiment of the present invention;

FIG. 5 is a perspective showing the luminescent in-coming call indicating means according to the first embodiment of the present invention is mounted on a mobile phone;

FIG. 6 is a partially exploded perspective of an in-coming call indicating means according to a second embodiment of the present invention being connected to a mobile phone;

FIG. 7 is an assembled perspective of the in-coming call indicating means of FIG. 6;

FIG. 8 is a perspective of an in-coming call indicating means for mobile phone according to a third embodiment of the present invention;

FIG. 9 illustrates a first manner of mounting a luminescent indicating line into a duct included in the in-coming call indicating means of FIG. 8; and

FIG. 10 illustrates a second manner of mounting the luminescent indicating line into a duct included in the in-coming call indicating means of FIG. 8.

### DETAILED DESCRIPTION OF THE PREFERRED EMBODIMENTS

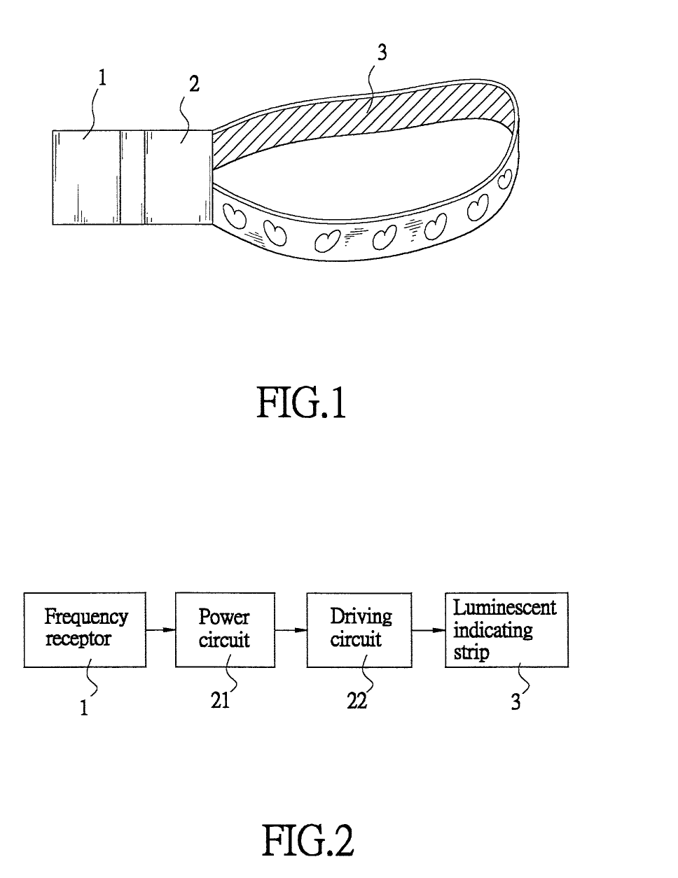

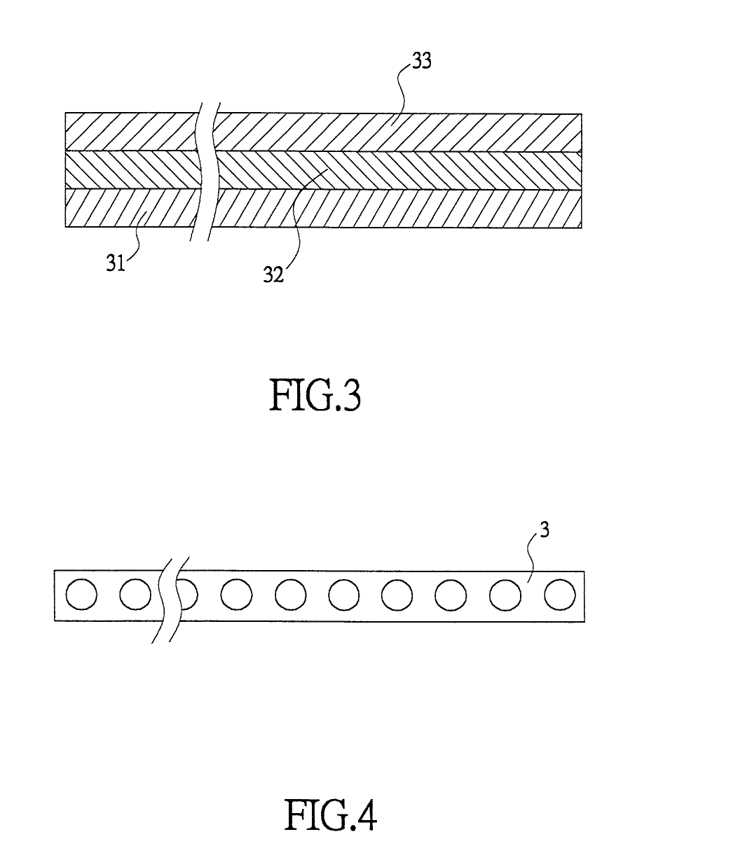

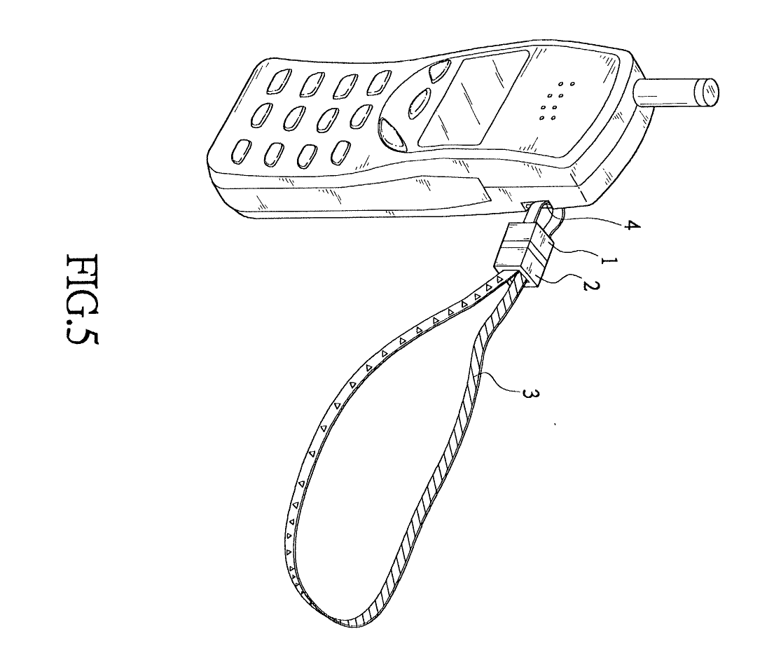

The present invention relates to an in-coming call indicating means for mobile phone and FIG. 1 illustrates a first embodiment thereof. As shown in FIG. 1, the in-coming call indicating means in this first embodiment mainly includes a frequency receptor 1 adapted to receive communicating signals sent to a mobile phone, and a luminescence starter 2 that includes a power circuit 21 and a driving circuit 22 adapted to receive a signal output by the frequency receptor 1 and to output driving power to a luminescent indicating strip 3 connected thereto. FIG. 2 is a block diagram of the in-coming call indicating means according to the first embodiment of the present invention. FIG. 3 is a fragmentary cross section of the luminescent indicating strip 3, showing that the strip 3 includes laminated carbon fiber layer 31, luminescent layer 32, and clear layer 33. On the luminescent layer 32, there is provided heart-shaped, dot-shaped or triangle-shaped patterns, as separately shown in FIGS. 1, 4 and 5, which give out luminescence whenever there is an in-coming call. The luminescent indicating strip 3 may be conveniently connected to a small hooking bar 4 on the mobile phone. The luminescent indicating strip 3 forms a considerably large ring that would easily expose from a bag for the mobile phone and easily visible from outside of the bag even when the mobile phone is received in the bag. The in-coming call indicating means of the present invention can therefore effectively notify a. mobile phone user of an in-coming call.

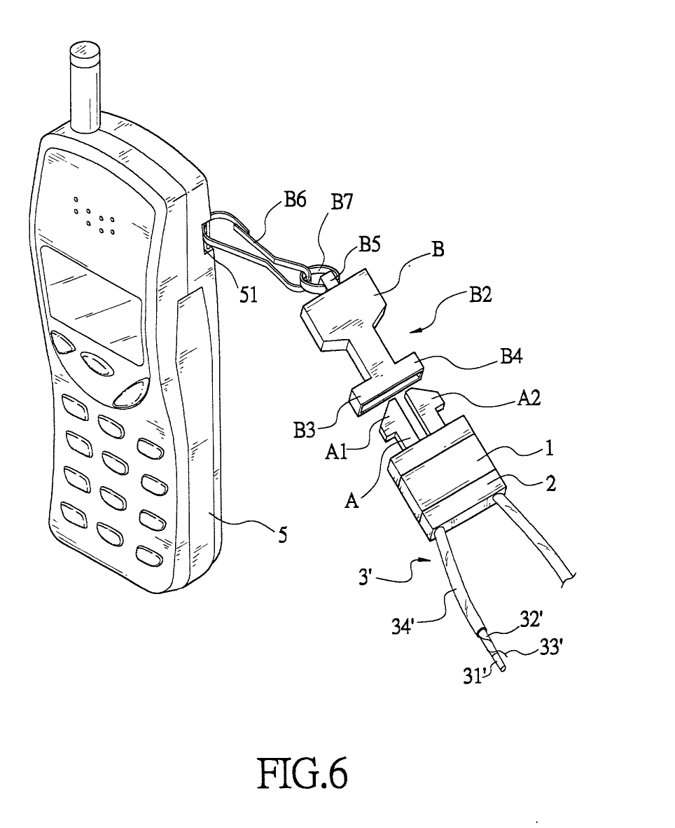

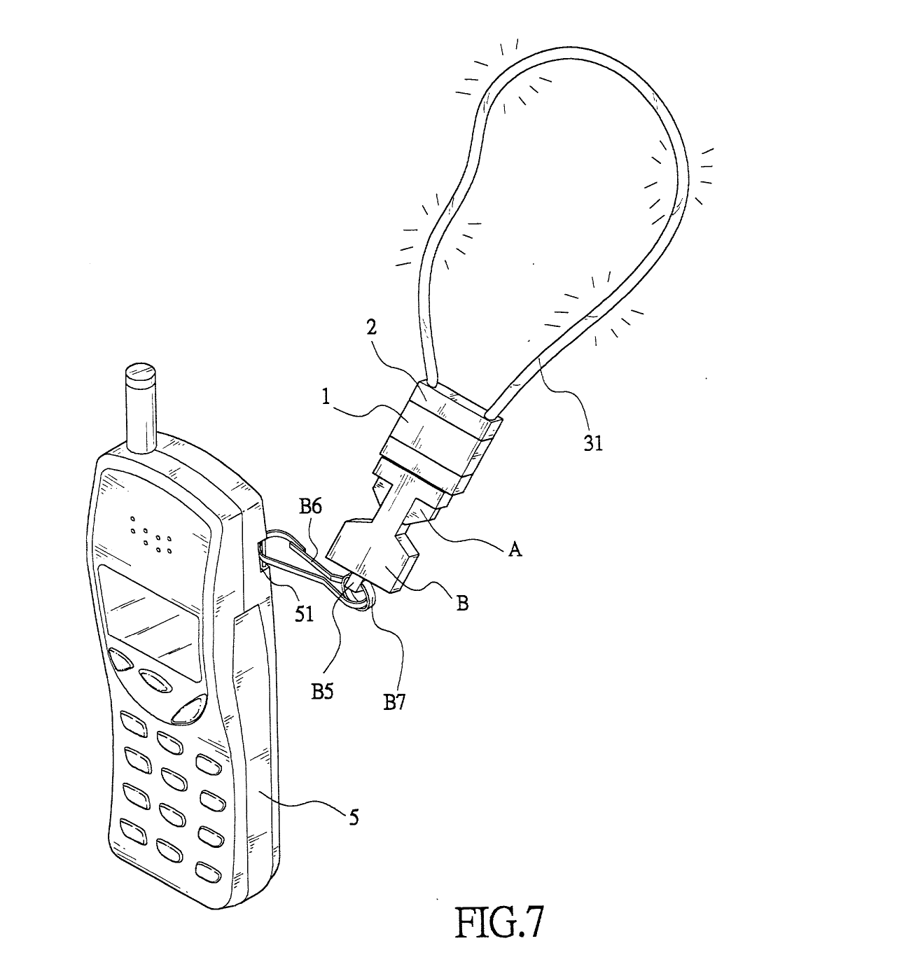

FIGS. 6 and 7 are partially exploded and assembled perspective views, respectively, of an in-coming call indicating means for mobile phone according to a second embodiment of the present invention. In this second embodiment, the in-coming call indicating means mainly includes a frequency receptor 1 adapted to receive communicating signals sent to a mobile phone 5, and a luminescence starter 2 that includes a power circuit 21 and a driving circuit 22 adapted to receive a signal output by the frequency receptor 1 and to output driving power to a luminescent indicating line 3′ connected thereto. As can be seen from FIG. 6, the luminescent indicating line 3′ includes a conductor 31′, a luminescent material 32′ wound around the conductor 31′, an electrode lead 33′ connected to an outer surface of the luminescent material 32′ , and an exterior protective layer 34′ coating the luminescent material 32′. The luminescent indicating line 3′ is adapted to hang on a user's wrist or neck to conveniently indicate in-coming calls while serves as an ornament.

In this second embodiment, the frequency receptor 1 may be connected to a hooking means A having two hooks A1 and A2. And a connector link B6 is connected at one end to a retaining hole 51 on the mobile phone 5 and at the other end to a ring B7 that is in turn connected to a retaining hole B5 provided on a hook receiver B. A front end B3 of the hook receiver B opposite to the retaining hole B5 is formed of an insertion slot B4, such that two retaining edges B1 and B2 are formed behind the insertion slot B4. The two hooks A1 and A2 of the hooking means A can be inserted into the insertion slot B4 to separately engage with the two retaining edges B1 and B2, so that the in-coming call indicating means of the present invention is connected to the mobile phone 5.

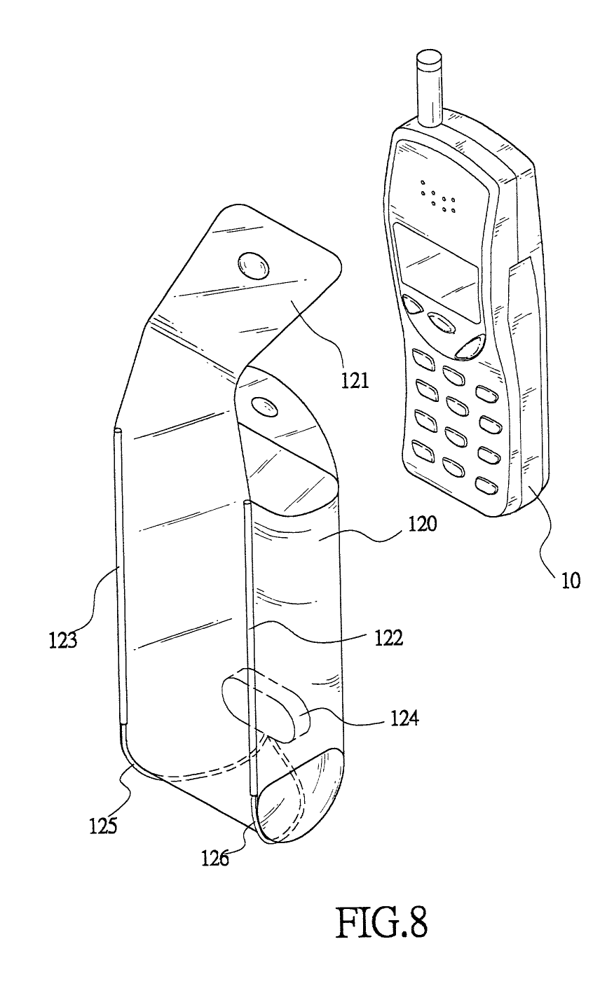

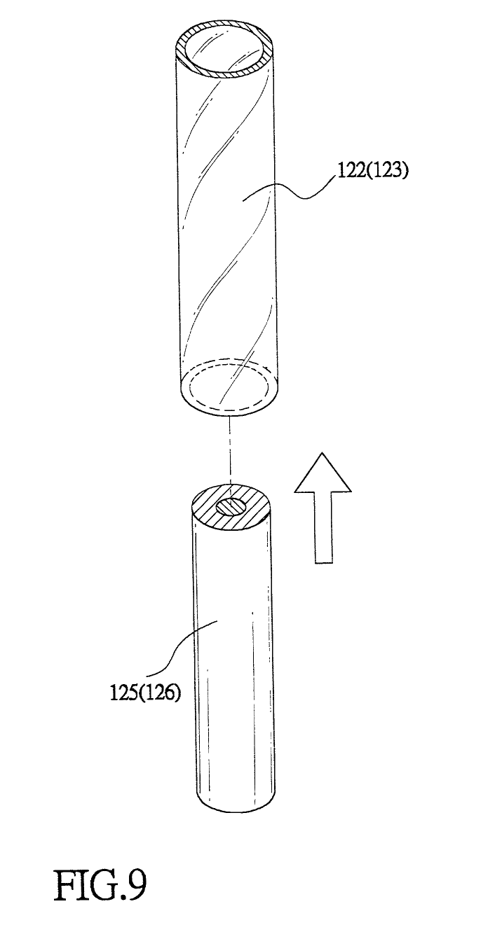

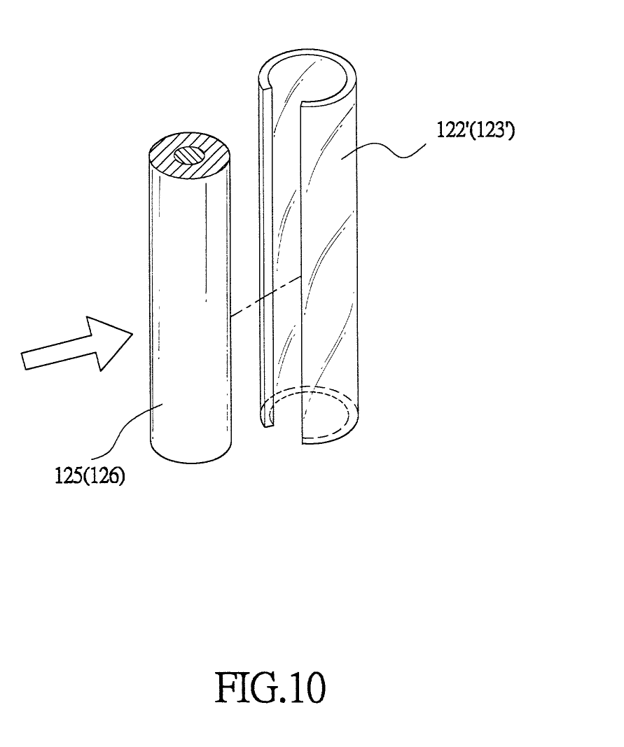

FIGS. 8, 9 and 10 illustrate a third embodiment of the present invention. In this third embodiment, the in-coming call indicating means for mobile phone mainly includes a main unit 124 that is provided on a bag 120 having a top cover 121 for receiving a mobile phone 110 therein and includes a frequency receptor and a luminescence starter that are similar to that provided in the first and the second embodiments, two hollow ducts 122, 123 that are directly provided on the bag 120, and two luminescent indicating lines 125, 126 that may be the luminescent strip 3 or 3′ provided in the first and the second embodiments, or a combination of thereof, for extending from the main unit 124 into the hollow ducts 123 and 122. With these arrangements, the in-coming call indicating means of the present invention is directly provided on the bag 120 for the mobile phone 110 and a user could always see the luminescence indicating means no matter whether the mobile phone 110 is received in the bag 120 or not.

FIG. 10 illustrates a duct 122′ or 123′ that has an axially extended slit via which a luminescent line 125 or 126 may be easily sideward pressed into the duct 122′ or 123′.

The luminescent strip or line included in the in-coming call indicating means of the present invention has large area and can therefore effectively notify a user of any in-coming call. Moreover, the luminescent strip or line may be hung on the user's wrist or neck to form a good ornament. The luminescent in-coming call indicating means of the present invention is therefore novel and practical for use.

It is understood that the present invention is illustrated with the description of some preferred embodiments thereof, and it is contemplated that many changes and modifications in the described embodiments can be carried out without departing from the scope of the invention and the scope of the present invention is intended to be limited only by the appended claims.

What is claimed is:

1. An in-coming call indicating means for mobile phone, comprising a frequency receptor that is adapted to receive communicating signals sent to a mobile phone, and a luminescence starter that includes a power circuit and a driving circuit adapted to receive a signal output by said frequency receptor and to output driving power to a luminescent indicating strip connected thereto; said luminescent indicating strip including laminated carbon fiber layer, luminescent layer, and clear layer, luminescent material in differently shaped patterns, such as hearts, dots or triangles, being provided on said luminescent layer to give out luminescence whenever there is an in-coming call.

2. An in-coming call indicating means for mobile phone, comprising a frequency receptor that is adapted to receive communicating signals sent to a mobile phone, and a luminescence starter that includes a power circuit and a driving circuit adapted to receive a signal output by said frequency receptor and to output driving power to a luminescent indicating line connected thereto; said luminescent indicating line including a conductor, a luminescent material wound around said conductor, an electrode lead connected to an outer surface of said luminescent material, and an exterior protective layer coating said luminescent material.

3. An in-coming call indicating means for mobile phone, comprising a main unit that is provided on a bag for receiving a mobile phone therein and includes a frequency receptor and a luminescence starter, multiple hollow ducts that are directly provided on said bag, and multiple luminescent indicating lines extended from said main unit into said hollow ducts.

4. An in-coming call indicating means for mobile phone as claimed in claim 3, wherein each of said ducts has an axially extended slit.
